(19) United States
(12) Patent Application Publication
(10) Pub. No.: US 2011/0234396 A1
(43) Pub. Date: Sep. 29, 2011

(54) FIRE AND EMERGENCY WARNING AND LOCATOR SYSTEM

(75) Inventors: Stephen Miller OLENICK, Ellicott City, MD (US); Douglas J. CARPENTER, Pasadena, MD (US); Jason Anthony SUTULA, Ellicott City, MD (US); Michael S. KLASSEN, Columbia, MD (US); Richard J. ROBY, Columbia, MD (US)

(73) Assignee: SAFEAWAKE, LLC, Columbia, MD (US)

(21) Appl. No.: 13/071,161

(22) Filed: Mar. 24, 2011

Related U.S. Application Data
(60) Provisional application No. 61/317,007, filed on Mar. 24, 2010.

(51) Int. Cl. G08B 1/08; G08B 3/00

(52) U.S. Cl. 340/539.13; 340/384.1

(57) ABSTRACT

Devices, systems, and methods for locating remote objects and notifying animals that alarms are active comprising detecting an alarm signal with an alarm sensor and a processor in communication with the alarm sensor and transmitting a locator signal and/or an audio signal having a frequency greater than 20 kHz in response to the detection of the alarm signal;

### CROSS REFERENCE TO RELATED APPLICATIONS

This disclosure claims priority from U.S. Provisional App. Ser. No. 61/317,007, entitled “Fire and Emergency Warning and Locator System,” filed Mar. 24, 2010, the entirety of which is incorporated by reference herein.

### BACKGROUND

There are millions of pet owners in the United States, and many of them consider their pets to be valued family members. During a fire or other emergency, a pet owner may try to find and evacuate the animal at the same time others are leaving the building. Pets are unable to be reliably taught fire escape plans and therefore must be physically located and led to an exit. As many owners consider pets to be valued family members, owners will often search for the pet during a fire and put their own safety at risk. Pets, when confronted with the blaring sound of smoke alarms and the smoke, heat, and flames from the fire, may elect to hide under furniture or in other locations. This may cost the owner and the pet valuable time. Quickly locating or staging the animal for escape may help the animal survive the fire and may also allow the owner to escape more quickly.

When a pet owner is not home, they may try to provide for their pet's rescue in case of emergency by placing a sticker on a door or window to alert firefighters to the presence of dogs or cats in the home. The owner may also install a monitored smoke detector, and a central station monitoring company can call the fire department to alert them of the fire and the presence of pets needing rescue. These methods require the fire department to find and save the animals, and in many cases rescue personnel may not arrive in time to save an animal trapped in a burning home.

Many of the same problems related to evacuating pets from buildings also apply to evacuating young children and disabled adults. Some minors are old enough to respond to an emergency and escape a building on their own, but others may be too young to understand the emergency or effectively escape. Some elderly and disabled adults may have similar problems evacuating buildings during a fire or other emergency.

Furthermore, fires spread more quickly in homes than they did in the past due to the prevalence of more synthetic materials in residences. Untenable conditions in a burning residence arise more quickly than ever before, and occupants often need to escape before the fire department arrives.

### BRIEF DESCRIPTIONS OF THE DRAWINGS

FIG. 1 depicts a block diagram of a warning and locator system including a listening device according to an embodiment of the invention.

FIG. 2 depicts a block diagram of a warning and locator system including a remote sensor device according to an embodiment of the invention.

FIG. 3 depicts a block diagram of a warning and locator system including a remote sensor device according to an embodiment of the invention.

FIG. 4 depicts a block diagram of a warning and locator system including a listening device and a remote locator system according to an embodiment of the invention.

FIG. 5 depicts a block diagram of a warning and locator system including a remote sensor device and a remote locator system according to an embodiment of the invention.

FIG. 6 depicts a block diagram of a warning and locator system including a remote sensor device and a remote locator system according to an embodiment of the invention.

FIG. 7 depicts a block diagram of a warning and locator system including a listening device and high frequency sounder according to an embodiment of the invention.

FIG. 8 depicts a block diagram of a warning and locator system including a remote sensor device and high frequency sounder according to an embodiment of the invention.

FIG. 9 depicts a block diagram of a warning and locator system including a remote sensor device and high frequency sounder according to an embodiment of the invention.

### DETAILED DESCRIPTION

Embodiments of the present invention may monitor for the activation of an alarm and assist a user in locating a pet, child, or disabled adult and/or stage a pet for escape. While the following embodiments are discussed in the context of smoke alarms installed in residences, it will be understood that this is for example only, and the scope of this disclosure is not limited to any specific alarm or location type. For example, embodiments may be used with toxic gas detectors, weather alerts, or other devices and may be used in any setting monitored by such a device. Furthermore, embodiments may be described in the context of pet collars and/or devices carried by children or disabled people, but it will be understood that this is for example only. Any embodiment may be used to locate or stage any individual, pet, or object. Example locator devices may include pet collars, pet harnesses, bracelets, necklaces, anklets, clothing or shoe clips, and sewn or iron-on patches. Also, while some method steps are delineated as separate steps for ease of understanding, any such steps should not be construed as necessarily distinct nor order dependent in their performance.

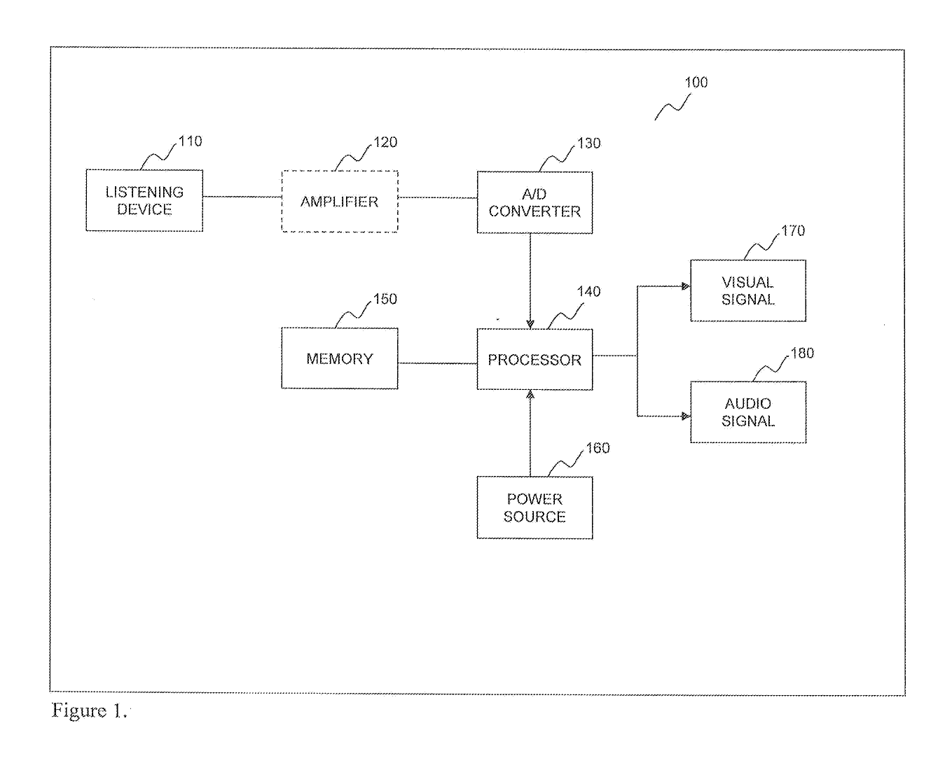

FIG. 1 depicts a block diagram of a warning and locator device 100 including a listening device 110 according to an embodiment of the invention. A pet collar or other locator device 100 may be equipped with a listening device 110. The listening device 110 may detect an alarm signal emitted by a smoke alarm or other alarm (not shown). The alarm signal may be an audible signal, a visual signal, a combination of audio and visual signals, or any other signal. The listening device 110 may monitor the smoke alarm using one or more of a variety of techniques. In an embodiment for monitoring an audible signal, the listening device 110 may comprise a microphone and optionally an amplifier 120 (shown in phantom in FIG. 1). Analog signals detected by the listening device 110 may be converted into digital signals by an analog-to-digital (A/D) converter 130. A processor 140 may employ an algorithm stored in a memory 150 to analyze received sounds and determine whether they are alarm signals. For example, the processor 140 may detect a standardized Temporal-3 tone which may be emitted by code compliant smoke alarms when smoke is detected. An example of an algorithm for listening for such an alarm is disclosed in U.S. Pat. No. 7,015,807, “Method and Apparatus for Indicating Activation of a Smoke Detector Alarm” (Roby et al., 2006). This patent is incorporated in its entirety herein by reference. It should be understood that other detection algorithms may be used. A visual signaling device 170, for example one or more light emitting diodes (LEDs), may be disposed on the locator device 100. Alternatively or additionally, an auditory signaling device 180, for example a speaker, may be disposed on the locator device 100. When the processor 140 detects an alarm signal, it may activate the signaling devices 170 and/or 180. The lights and/or sound may allow a person such as a pet owner or fireman to more easily locate the wearer of the locator device 100. The components of the locator device 100, such as the listening device 110, amplifier 120, A/D converter 130, processor 140, and signaling devices 170 and 180, may be powered by a power source 160, which may comprise a battery or other suitable power source.

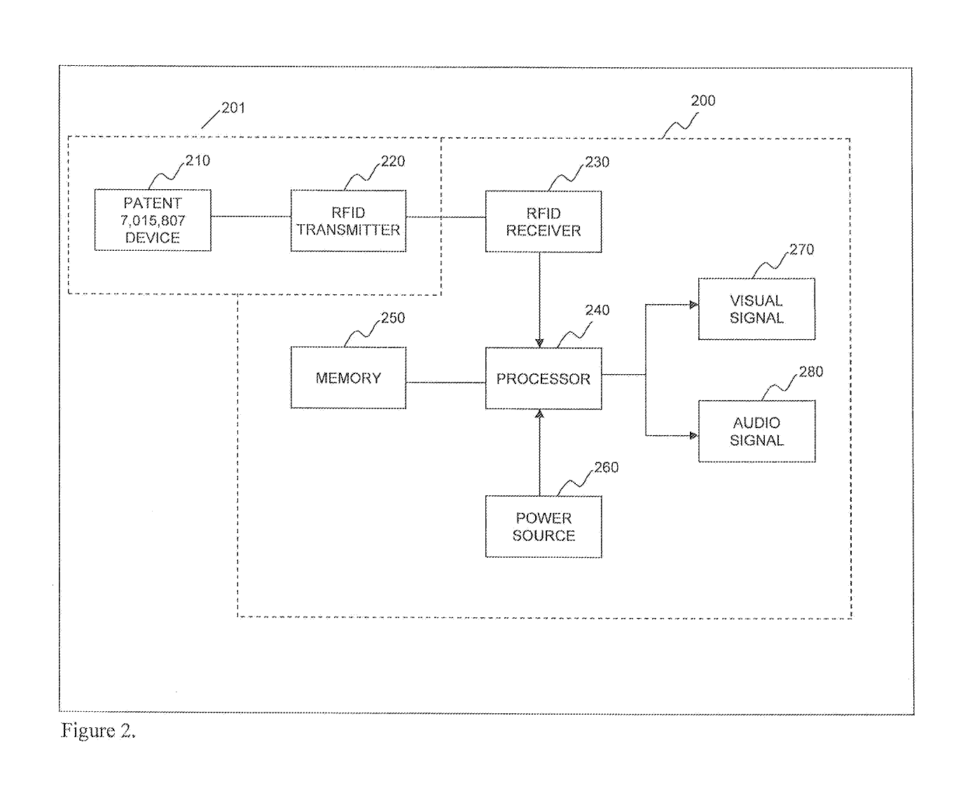

FIG. 2 depicts a block diagram of a warning and locator system including a remote sensor device 201 according to an embodiment of the invention. A remote sensor device 201 may be disposed within a residence or other location. The remote sensor device 201 may include an alarm monitor 210. The alarm monitor 210 may analyze received sounds or signals from a smoke alarm or other alarm (not shown) to determine whether they are alarm signals. As with the locator device 100 of FIG. 1, the alarm monitor 210 may use the technology described in U.S. Pat. No. 7,015,807 to monitor for alarm activity, or it may use other suitable algorithms or systems. The remote sensor device 201 may also be equipped with a transmitter 220. In the example of FIG. 2, the transmitter 220 is an RFID transmitter, but any type of signal may be transmitted by the transmitter 220. For example, the transmitter 220 may transmit a radio signal or an infrared signal. When the alarm monitor 210 detects an alarm signal, the transmitter 220 may transmit a signal. A locator device 200 may be equipped with a receiver 230. In the example of FIG. 2, the receiver 230 is an RFID receiver, but other types of receivers 230 may be used. A receiver 230 may be selected to receive the type of signals sent by the transmitter 220. When the transmitter 220 is transmitting a signal indicating that an alarm is active, the receiver 230 may receive the transmitted signal. The receiver 230 may communicate to the processor 240 that an alarm is active. The processor 240 may activate a visual signaling device 270 and/or an auditory signaling device 280. The lights and/or sound may allow a person such as a pet owner or fireman to more easily locate the wearer of the locator device 200. The components of the locator device 200, such as the receiver 230, processor 240, and signaling devices 270 and 280, may be powered by a power source 260, which may comprise a battery or other suitable power source. The components of the remote sensor device 201 may be powered by a separate power source which is not shown.

In some embodiments, the alarm monitor 210 may be replaced with an RF receiver. The RF receiver may be tuned to a preset radio station on which Emergency Broadcast System signals are generated in the event of a natural disaster such as an earthquake. The alarm monitor 210 may detect the emergency broadcast signal, in some embodiments by using the algorithm disclosed in U.S. Pat. No. 7,015,807 or a similar algorithm. In response, the transmitter 220 may transmit a signal to alert the locator device 200.

In some embodiments, the alarm monitor 210 may be integrated into or placed in communication with a fire alarm control panel. A fire alarm control panel may be present in some locations to centrally monitor sensors such as smoke detectors, heat detectors, manual fire alarms, and other inputs. The fire alarm control panel may be configured to alert an alarm monitor 210 of the presence of fire or may directly communicate the presence of fire to the receiver 230.

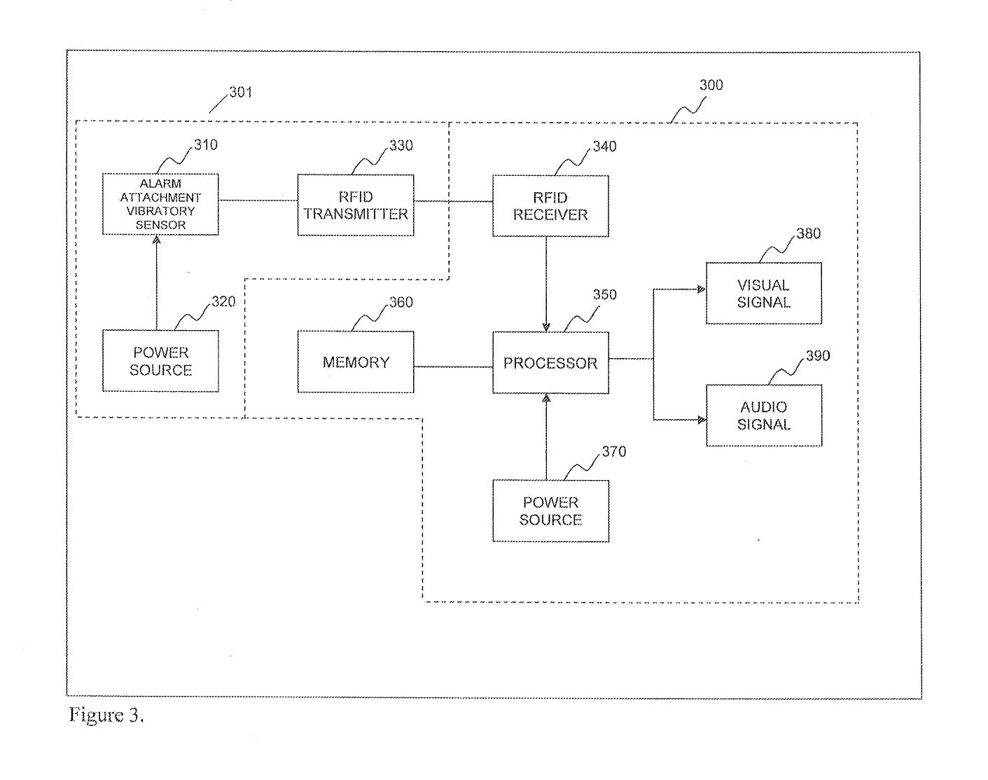

FIG. 3 depicts a block diagram of a warning and locator system including a remote sensor device 301 according to an embodiment of the invention. A remote sensor device 301 may be attached to or located near a smoke alarm or other alarm (not shown). The remote sensor device 301 may include a vibration sensor 310. When an alarm sounds, it may vibrate, and the vibration sensor 310 may detect this vibration. The remote sensor device 301 may also be equipped with a transmitter 330. In the example of FIG. 3, the transmitter 330 is an RFID transmitter, but any type of signal may be transmitted by the transmitter 330. For example, the transmitter 330 may transmit a radio signal or an infrared signal. When the vibration sensor 310 detects a vibration in the alarm, the transmitter 330 may transmit a signal. A locator device 300 may be equipped with a receiver 340. In the example of FIG. 3, the receiver 340 is an RFID receiver, but other types of receivers 340 may be used. A receiver 340 may be selected to receive the type of signals sent by the transmitter 330. When the transmitter 330 is transmitting a signal indicating that an alarm is active, the receiver 340 may receive the transmitted signal. The receiver 340 may communicate to the processor 350 that an alarm is active. The processor 350 may activate a visual signaling device 380 and/or an auditory signaling device 390. The lights and/or sound may allow a person such as a pet owner or fireman to more easily locate the wearer of the locator device 300. The components of the locator device 300, such as the receiver 340, processor 350, and signaling devices 380 and 390, may be powered by a power source 370, which may comprise a battery or other suitable power source. The components of the remote sensor device 301 may be powered by a separate power source 320.

In the embodiments of FIGS. 1-3, or in any other embodiments employing signaling devices allowing a pet owner, guardian, or rescue worker to locate a pet or person, signaling devices may be selected to be readily observable in emergency situations. For example, visual signaling devices 170, 270, 380 may have a luminous flux of 15 lumens or greater, and auditory signaling devices 180, 280, 390 may have a sound intensity of 60 decibels or greater. On the other hand, upper limits of lumens or decibels may be selected to avoid causing or adding to distress for a pet wearing a locator device 100, 200, 300.

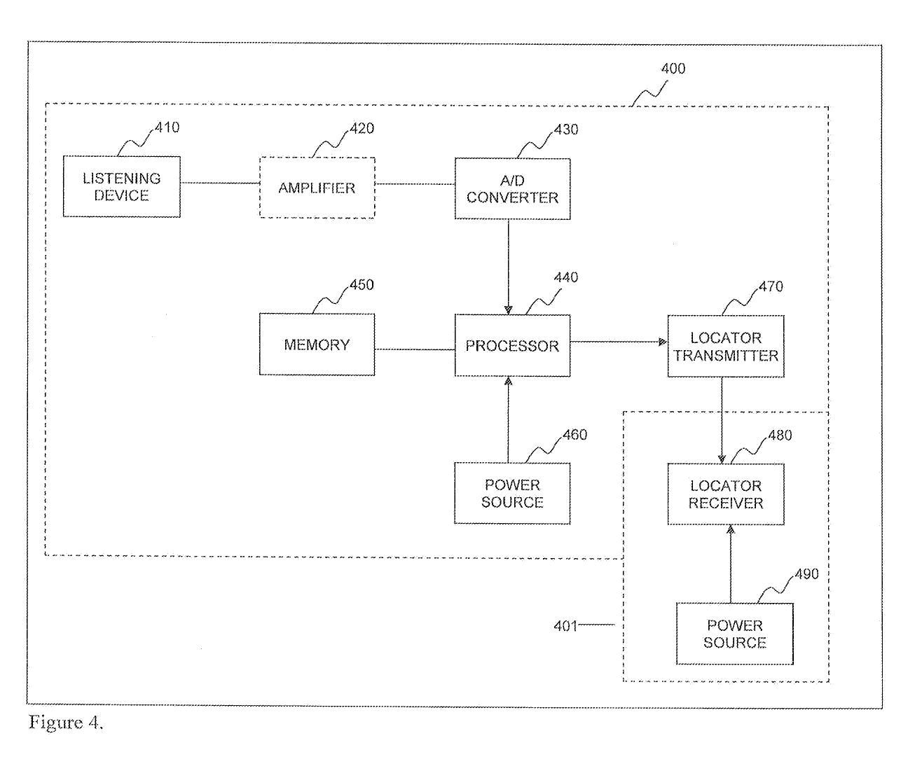

FIG. 4 depicts a block diagram of a warning and locator system including a locator device 400 and a remote locator system 401 according to an embodiment of the invention. As in the embodiment of FIG. 1, a pet collar or other locator device 400 may be equipped with a listening device 410. The listening device 410 may detect an alarm signal emitted by a smoke alarm or other alarm (not shown). For example, the listening device 410 may comprise a microphone and optionally an amplifier 420 (shown in phantom in FIG. 4), but other listening devices 410 may be employed, and the listening device 410 may detect an audible, visible, or other type of alarm signal. Analog signals detected by the listening device 410 may be converted into digital signals by an A/D converter 430. A processor 440 may employ an algorithm stored in a memory 450 to analyze received sounds and determine whether they are alarm signals. For example, the processor 440 may detect a standardized Temporal-3 tone using the algorithm of U.S. Pat. No. 7,015,807. Other detection algorithms may be used, and other alarm signals may be detected. The locator device 400 may also include a locator transmitter 470 in communication with the processor 440. The locator transmitter 470 may transmit any kind of signal, such as a radio signal or an infrared signal. When the processor 440 detects alarm signal activity, the locator transmitter 470 may transmit a signal. The components of the locator device 400, such as the listening device 410, amplifier 420, A/D converter 430, processor 440, and transmitter 470, may be powered by a power source 460, which may comprise a battery or other suitable power source.

A remote receiver 401 may be provided. The remote receiver 401 may be a portable or fixed device monitored by a user such as a pet owner, parent, or guardian. The remote receiver 401 may include a locator receiver 480. The locator receiver 480 may receive the signal transmitted by the locator transmitter 470. The remote receiver 401 may include a signaling apparatus (not shown). The signaling apparatus may display an auditory or visual alarm to the user when the locator receiver 480 receives a signal indicating that an alarm signal 410 is active. In some embodiments the alarm displayed by the remote receiver 401 may vary based on distance and/or direction between the remote receiver 401 and the locator device 400. The remote receiver 401 may sense the proximity of the signal transmitted by the locator device 400. For example, an intermittent audible or visual signal may vary in frequency based on the distance between the remote receiver 401 and the locator device 400. This may allow a user of the remote receiver 401 to determine whether they are heading towards the pet or person wearing the locator device 400. In some embodiments, other locating systems such as Global Positioning System (GPS) receivers or other locating technologies may be provided in the locator device 400 and/or the remote receiver 401. For example, the locator device 400 may include a GPS receiver and transmit its GPS coordinates to the remote receiver 401. The remote receiver 401 may include a display that shows the location of the locator device 400. The remote receiver 401 may also include a GPS receiver and show the location of the locator device 400 and the remote receiver 401 on a display, so that a user can find the locator device 400 by comparing locations. In some embodiments, other technologies such as motion sensors or video cameras may be included in the remote receiver 401 to assist a user in finding the animal or person wearing the locator device 400. The locator receiver 480 and signaling apparatus of the remote receiver 401 may be powered by a power source 490.

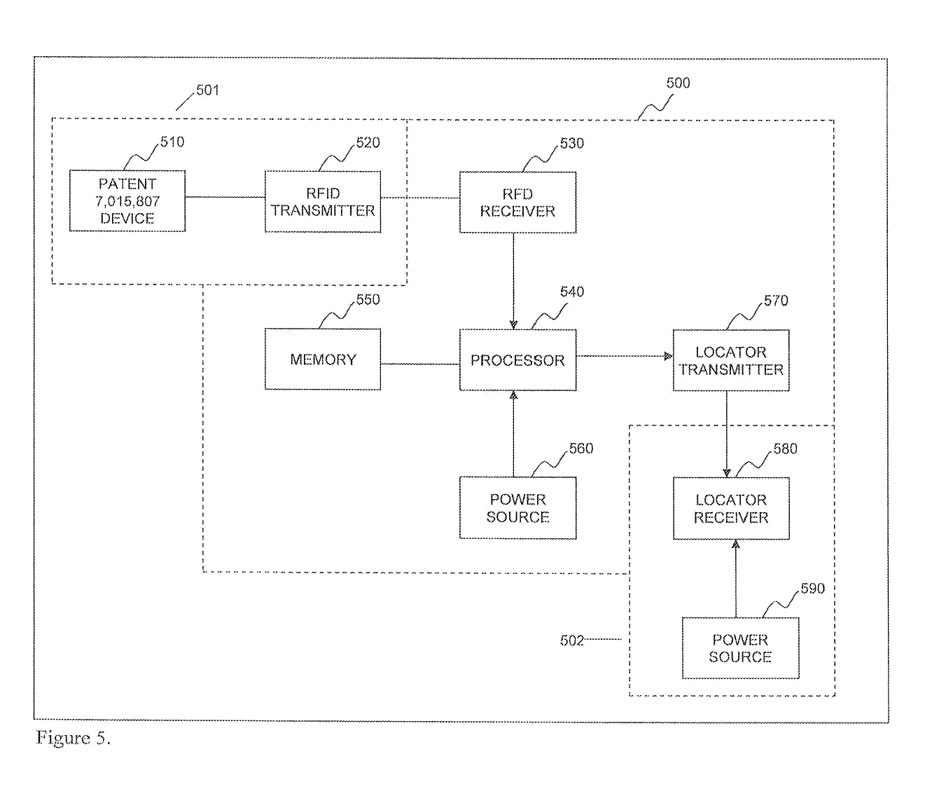

FIG. 5 depicts a block diagram of a warning and locator system including a remote sensor device 501 and a remote locator system 502 according to an embodiment of the invention. A remote sensor device 501 may be disposed within a residence or other location. The remote sensor device 501 may include an alarm monitor 510. The alarm monitor 510 may analyze received sounds or signals from a smoke alarm or other alarm (not shown) to determine whether they are alarm signals. As with the locator device 100 of FIG. 1, the alarm monitor 510 may use the technology described in U.S. Pat. No. 7,015,807 to monitor for alarm activity, or it may use other suitable algorithms or systems. The remote sensor device 501 may also be equipped with a transmitter 520. In the example of FIG. 5, the transmitter 520 is an RFID transmitter, but any type of signal may be transmitted by the transmitter 520. For example, the transmitter 520 may transmit a radio signal or an infrared signal. When the alarm monitor 510 detects an alarm signal, the transmitter 520 may transmit a signal. A locator device 500 may be equipped with a receiver 530. In the example of FIG. 5, the receiver 530 is an RFID receiver, but other types of receivers 530 may be used. A receiver 530 may be selected to receive the type of signals sent by the transmitter 520. When the transmitter 520 is transmitting a signal indicating that an alarm is active, the receiver 530 may receive the transmitted signal. The receiver 530 may communicate to the processor 540 that an alarm is active. The locator device 500 may also include a locator transmitter 570 in communication with the processor 540. The locator transmitter 570 may transmit any kind of signal, such as a radio signal or infrared signal. When the processor 540 detects alarm signal 510 activity, the locator transmitter 570 may transmit a signal. The components of the locator device 500, such as the receiver 530, processor 540, and transmitter 570, may be powered by a power source 560, which may comprise a battery or other suitable power source. The components of the remote sensor device 501 may be powered by a separate power source which is not shown.

A remote receiver 502 may be provided. The remote receiver 502 may be a portable or fixed device monitored by a user such as a pet owner, parent, or guardian. The remote receiver 502 may include a locator receiver 580. The locator receiver 580 may receive the signal transmitted by the locator transmitter 570. The remote receiver 502 may include a signaling apparatus (not shown). The signaling apparatus may display an auditory or visual alarm to the user when the locator receiver 580 receives a signal indicating that an alarm signal 510 is active. In some embodiments the alarm displayed by the remote receiver 502 may vary based on distance and/or direction between the remote receiver 502 and the locator device 500. The remote receiver 502 may sense the proximity of the signal transmitted by the locator device 500. For example, an intermittent audible or visual signal may vary in frequency based on the distance between the remote receiver 502 and the locator device 500. This may allow a user of the remote receiver 502 to determine whether they are heading towards the pet or person wearing the locator device 500. In some embodiments, other locating systems such as GPS receivers or other locating technologies may be provided in the locator device 500 and/or the remote receiver 502. For example, the locator device 500 may include a GPS receiver and transmit its GPS coordinates to the remote receiver 502. The remote receiver 502 may include a display that shows the location of the locator device 500. The remote receiver 502 may also include a GPS receiver and show the location of the locator device 500 and the remote receiver 502 on a display, so that a user can find the locator device 500 by comparing locations. In some embodiments, other technologies such as motion sensors or video cameras may be included in the remote receiver 502 to assist a user in finding the animal or person wearing the locator device 500. The locator receiver 580 and signaling apparatus of the remote receiver 502 may be powered by a power source 590.

In some embodiments, the alarm monitor 510 may be replaced with an RF receiver. The RF receiver may be tuned to a preset radio station on which Emergency Broadcast System signals are generated in the event of a natural disaster such as an earthquake. The alarm monitor 510 may detect the emergency broadcast signal, in some embodiments by using the algorithm disclosed in U.S. Pat. No. 7,015,807 or a similar algorithm. In response, the transmitter 520 may transmit a signal to alert the locator device 500.

In some embodiments, the alarm monitor 510 may be integrated into or placed in communication with a fire alarm control panel. A fire alarm control panel may be present in some locations to centrally monitor sensors such as smoke detectors, heat detectors, manual fire alarms, and other inputs. The fire alarm control panel may be configured to alert an alarm monitor 510 of the presence of fire or may directly communicate the presence of fire to the receiver 530.

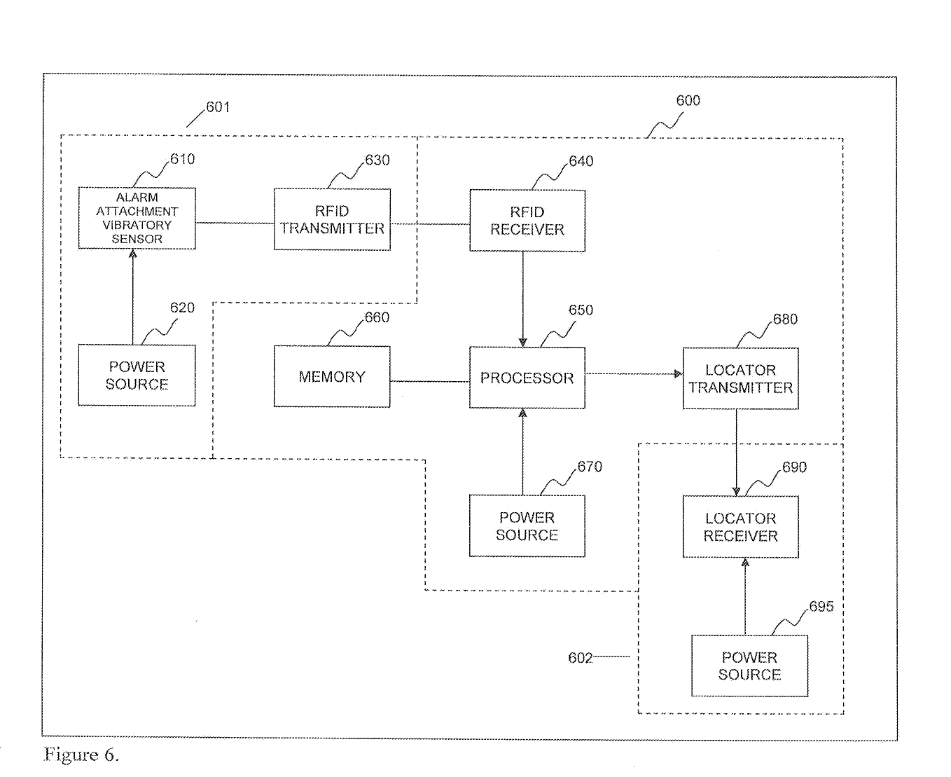

FIG. 6 depicts a block diagram of a warning and locator system including a remote sensor device 601 and a remote locator system 602 according to an embodiment of the invention. A remote sensor device 601 may be attached to or located near a smoke alarm or other alarm (not shown). The remote sensor device 601 may include a vibration sensor 610. When an alarm sounds, it may vibrate, and the vibration sensor 610 may detect this vibration. The remote sensor device 601 may also be equipped with a transmitter 630. In the example of FIG. 6, the transmitter 630 is an RFID transmitter, but any type of signal may be transmitted by the transmitter 630. For example, the transmitter 630 may transmit a radio signal or an infrared signal. When the vibration sensor 610 detects a vibration in the alarm, the transmitter 630 may transmit a signal. A locator device 600 may be equipped with a receiver 640. In the example of FIG. 6, the receiver 640 is an RFID receiver, but other types of receivers 640 may be used. A receiver 640 may be selected to receive the type of signals sent by the transmitter 630. When the transmitter 630 is transmitting a signal indicating that an alarm is active, the receiver 640 may receive the transmitted signal. The receiver 640 may communicate to the processor 650 that an alarm is active. The locator device 600 may also include a locator transmitter 680 in communication with the processor 650. The locator transmitter 680 may transmit any kind of signal, such as a radio signal or an infrared signal. When the processor 650 detects alarm signal 610 activity, the locator transmitter 680 may transmit a signal. The components of the locator device 600, such as the receiver 640, processor 650, and transmitter 680, may be powered by a power source 670, which may comprise a battery or other suitable power source. The components of the remote sensor device 601 may be powered by a separate power source 620.

A remote receiver 602 may be provided. The remote receiver 602 may be a portable or fixed device monitored by a user such as a pet owner, parent, or guardian. The remote receiver 602 may include a locator receiver 690. The locator receiver 690 may receive the signal transmitted by the locator transmitter 680. The remote receiver 602 may include a signaling apparatus (not shown). The signaling apparatus may display an auditory or visual alarm to the user when the locator receiver 690 receives a signal indicating that an alarm signal 610 is active. In some embodiments the alarm displayed by the remote receiver 602 may vary based on distance and/or direction between the remote receiver 602 and the locator device 600. The remote receiver 602 may sense the proximity of the signal transmitted by the locator device 600. For example, an intermittent audible or visual signal may vary in frequency based on the distance between the remote receiver 602 and the locator device 600. This may allow a user of the remote receiver 602 to determine whether they are heading towards the pet or person wearing the locator device 600. In some embodiments, other locating systems such as GPS receivers or other locating technologies may be provided in the locator device 600 and/or the remote receiver 602. For example, the locator device 600 may include a GPS receiver and transmit its GPS coordinates to the remote receiver 602. The remote receiver 602 may include a display that shows the location of the locator device 600. The remote receiver 602 may also include a GPS receiver and show the location of the locator device 600 and the remote receiver 602 on a display, so that a user can find the locator device 600 by comparing locations. In some embodiments, other technologies such as motion sensors or video cameras may be included in the remote receiver 602 to assist a user in finding the animal or person wearing the locator device 600. The locator receiver 690 and signaling apparatus of the remote receiver 602 may be powered by a separate power source 695.

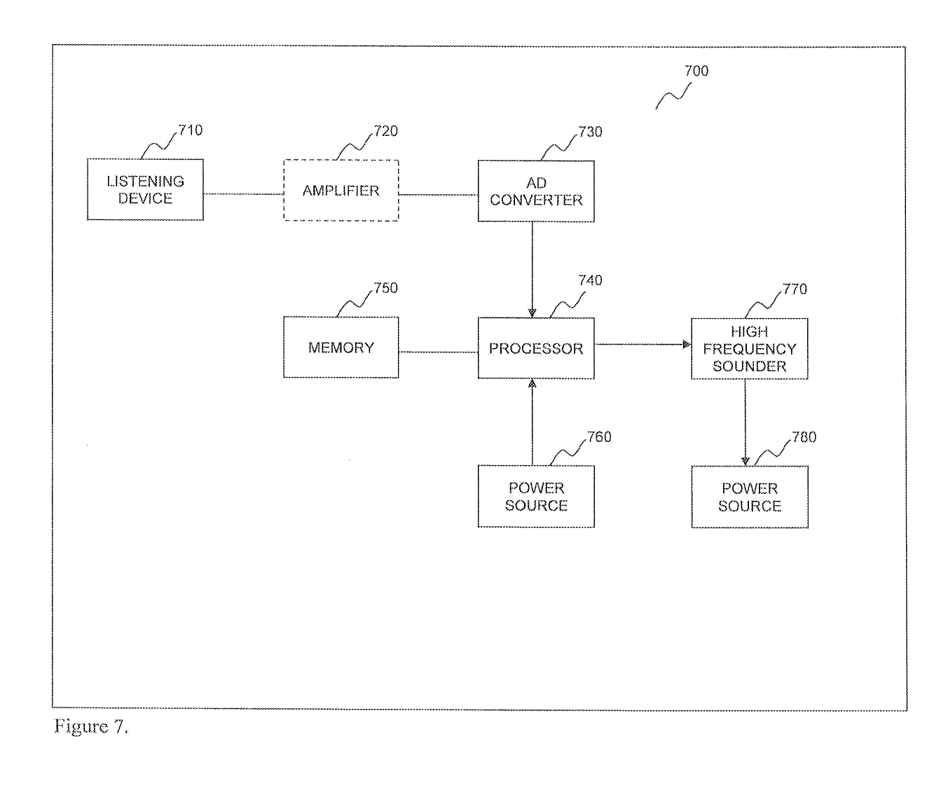

FIG. 7 depicts a block diagram of a warning and locator device 700 including a listening device 710 and high frequency sounder 770 according to an embodiment of the invention. A sound box 700 may be equipped with a listening device 710. The listening device 710 may detect an alarm signal emitted by a smoke alarm or other alarm (not shown). The alarm signal may be an audible signal, a visual signal, a combination of audio and visual signals, or any other signal. The listening device 710 may monitor the smoke alarm using one or more of a variety of techniques. In an embodiment for monitoring an audible signal, the listening device 710 may comprise a microphone and optionally an amplifier 720 (shown in phantom in FIG. 7). Analog signals detected by the listening device 710 may be converted into digital signals by an A/D converter 730. A processor 740 may employ an algorithm stored in a memory 750 to analyze received sounds and determine whether they are alarm signals. For example, the processor 740 may detect a standardized Temporal-3 tone using an algorithm such as the one disclosed in U.S. Pat. No. 7,015,807. It should be understood that other detection algorithms may be used.

A high frequency sounder 770 may be disposed on the sound box 700. The high frequency sounder 770 may be a speaker or sound generator configured to emit sounds at frequencies that can be heard by dogs but not humans. For example, frequencies of sound between approximately 20,000 and 60,000 Hz can be heard by dogs but not humans (Condon, 2003). When the processor 740 detects an alarm signal, it may cause the high frequency sounder 770 to emit an intermittent or constant signal in the 20-60 kHz range similar to a dog whistle. This may direct a dog to proceed to a known location. The dog may thereby be staged for rescue by an owner who knows the location. In some embodiments, sounds may be alternatively or additionally emitted in a frequency range that humans can hear. These sounds may be, for example, human speech directing a child or other household occupant to safety. Some embodiments may include a “training” mode. A user may be able to input a command to the processor 740 to activate the high frequency sounder 770 while there is no active alarm signal. The user may then train the pet to proceed to a known location in response to the sound. The components of the sound box 700, such as the listening device 710, amplifier 720, A/D converter 730, and processor 740 may be powered by a power source 760, which may comprise a battery or other suitable power source. The high frequency sounder 770 may be powered by the power source 760 or by a separate power source 780 as shown in the example of FIG. 7.

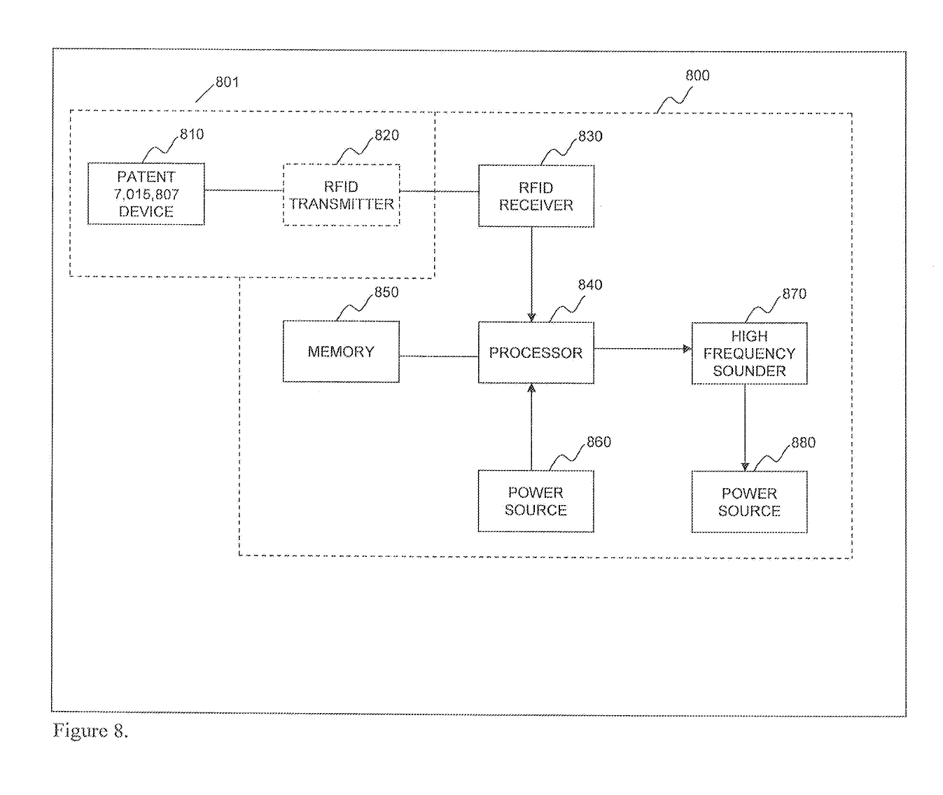

FIG. 8 depicts a block diagram of a warning and locator system including a remote sensor device 801 and high frequency sounder 870 according to an embodiment of the invention. A remote sensor device 801 may be disposed within a residence or other location. The remote sensor device 801 may include an alarm monitor 810. The alarm monitor 810 may analyze received sounds or signals from a smoke alarm or other alarm (not shown) to determine whether they are alarm signals. As with the locator device 100 of FIG. 1, the alarm monitor 810 may use the technology described in U.S. Pat. No. 7,015,807 to monitor for alarm activity, or it may use other suitable algorithms or systems. The remote sensor device 801 may also be equipped with a transmitter 820. In the example of FIG. 8, the transmitter 820 is an RFID transmitter, but any type of signal may be transmitted by the transmitter 820. For example, the transmitter 820 may transmit a radio signal or an infrared signal. When the alarm monitor 810 detects an alarm signal, the transmitter 820 may transmit a signal. A sound box 800 may be equipped with a receiver 830. In the example of FIG. 8, the receiver 830 is an RFID receiver, but other types of receivers 230 may be used. A receiver 830 may be selected to receive the type of signals sent by the transmitter 820. When the transmitter 820 is transmitting a signal indicating that an alarm is active, the receiver 830 may receive the transmitted signal.

A high frequency sounder 870 may be disposed on the sound box 800. The high frequency sounder 870 may be a speaker or sound generator configured to emit sounds at frequencies that can be heard by dogs but not humans. The receiver 830 may communicate to the processor 840 that an alarm is active. In turn, the processor 840 may cause the high frequency sounder 870 to emit an intermittent or constant signal in the 20-60 kHz range similar to a dog whistle. This may direct a dog to proceed to a known location. The dog may thereby be staged for rescue by an owner who knows the location. In some embodiments, sounds may be alternatively or additionally emitted in a frequency range that humans can hear. These sounds may be, for example, human speech directing a child or other household occupant to safety. As described above with respect to FIG. 7, some embodiments may include a “train” mode. The components of the sound box 800, such as the receiver 830 and processor 840 may be powered by a power source 860, which may comprise a battery or other suitable power source. The components of the remote sensor device 801 may be powered by a separate power source which is not shown. The high frequency sounder 870 may be powered by the power source 860 or by a separate power source 880 as shown in the example of FIG. 8.

In some embodiments, the alarm monitor 810 may be replaced with an RF receiver. The RF receiver may be tuned to a preset radio station on which Emergency Broadcast System signals are generated in the event of a natural disaster such as an earthquake. The alarm monitor 810 may detect the emergency broadcast signal, in some embodiments by using the algorithm disclosed in U.S. Pat. No. 7,015,807 or a similar algorithm. In response, the transmitter 820 may transmit a signal to alert the sound box 800.

In some embodiments, the alarm monitor 810 may be integrated into or placed in communication with a fire alarm control panel. A fire alarm control panel may be present in some locations to centrally monitor sensors such as smoke detectors, heat detectors, manual fire alarms, and other inputs. The fire alarm control panel may be configured to alert an alarm monitor 810 of the presence of fire or may directly communicate the presence of fire to the receiver 830.

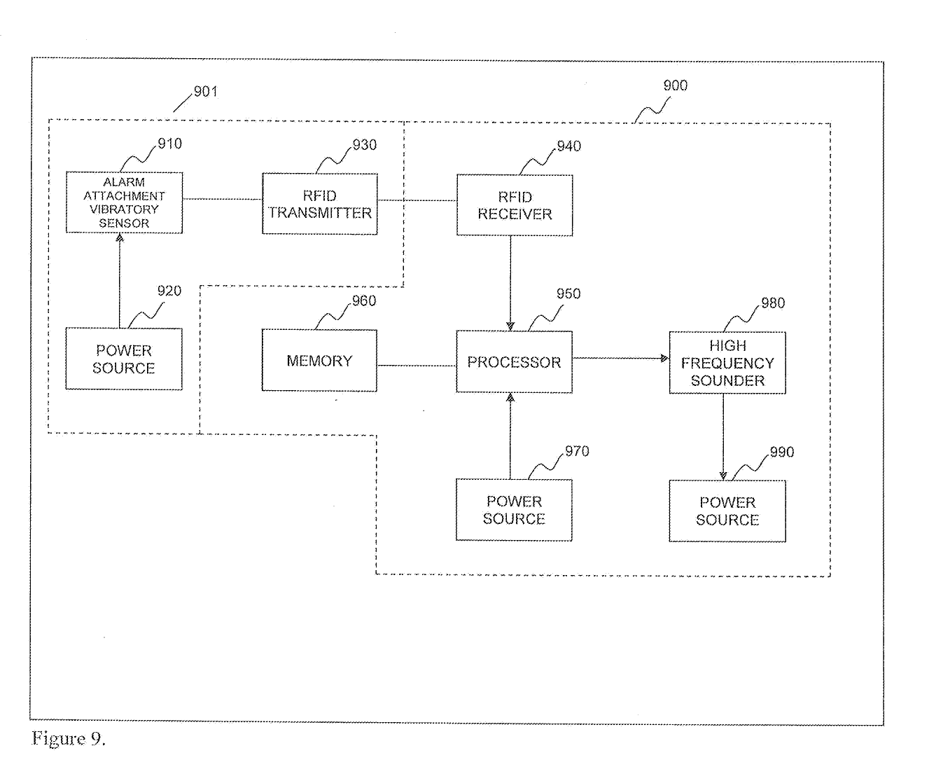

FIG. 9 depicts a block diagram of a warning and locator system including a remote sensor device 901 and high frequency sounder 980 according to an embodiment of the invention. A remote sensor device 901 may be attached to or located near a smoke alarm or other alarm (not shown). The remote sensor device 901 may include a vibration sensor 910. When an alarm sounds, it may vibrate, and the vibration sensor 910 may detect this vibration. The remote sensor device 901 may also be equipped with a transmitter 930. In the example of FIG. 9, the transmitter 930 is an RFID transmitter, but any type of signal may be transmitted by the transmitter 930. For example, the transmitter 930 may transmit a radio signal or an infrared signal. When the vibration sensor 910 detects a vibration in the alarm, the transmitter 930 may transmit a signal. A sound box 900 may be equipped with a receiver 940. In the example of FIG. 9, the receiver 940 is an RFID receiver, but other types of receivers 940 may be used. A receiver 940 may be selected to receive the type of signals sent by the transmitter 930. When the transmitter 930 is transmitting a signal indicating that an alarm is active, the receiver 940 may receive the transmitted signal.

A high frequency sounder 980 may be disposed on the sound box 900. The high frequency sounder 980 may be a speaker or sound generator configured to emit sounds at frequencies that can be heard by dogs but not humans. The receiver 940 may communicate to the processor 950 that an alarm is active. In turn, the processor 950 may cause the high frequency sounder 980 to emit an intermittent or constant signal in the 20-60 kHz range similar to a dog whistle. This may direct a dog to proceed to a known location. The dog may thereby be staged for rescue by an owner who knows the location. In some embodiments, sounds may be alternatively or additionally emitted in a frequency range that humans can hear. These sounds may be, for example, human speech directing a child or other household occupant to safety. As described above with respect to FIG. 7, some embodiments may include a “train” mode. The components of the sound box 900, such as the receiver 940 and processor 950 may be powered by a power source 970, which may comprise a battery or other suitable power source. The high frequency sounder 980 may be powered by the power source 970 or by a separate power source 990 as shown in the example of FIG. 9. The components of the remote sensor device 901 may be powered by a separate power source 920.

Any of the above embodiments, or any other embodiments, may be modified to also allow a user to manually activate the locator device or sound box. For example, in the embodiments of FIG. 1, 4, or 7, a listening device listens for an alarm signal. A remote control may be provided that may transmit a signal when activated that is received by the listening device and causes the processor to activate the visual and/or audio signal, transmit a locator signal to the locator receiver, or activate the high frequency sounder. In the embodiments of FIG. 2, 3, 5, 6, 8, or 9, an RFID or other receiver receives a signal indicating that an alarm is active. A remote control may be provided that may transmit a signal when activated that is received by the receiver and causes the processor to activate the visual and/or audio signal, transmit a locator signal to the locator receiver, or activate the high frequency sounder. Alternatively, a dedicated test receiver in communication with the processor may be added to any of the embodiments. A remote control may be provided that may transmit a signal when activated that is received by the dedicated test receiver and causes the processor to activate the visual and/or audio signal, transmit a locator signal to the locator receiver, or activate the high frequency sounder. In many embodiments including devices communicating remotely with one another, such as embodiments with remote locator or remote sensor devices communicating with locator devices or sound boxes, the various devices may be located in a common area or structure.

In any embodiments including a locator device, the locator device may be worn or carried by any animal in a variety of ways. For example, the locator device may be attached to or incorporated within a pet collar or harness, or the locator device may be pinned to an article of clothing or attached to a chain to be worn around a person's neck. It will be understood that the term “animal” may indicate any member of the animal kingdom, including humans and animals not commonly kept as pets.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages, are presented for example purposes only. The disclosed methodology and system are each sufficiently flexible and configurable, such that it may be utilized in ways other than that shown.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. §112, paragraph 6. Claims that do not expressly include the phrase “means for” or “step for” are not to be interpreted under 35 U.S.C. §112, paragraph 6.

What is claimed is:

1. A locator device comprising:
a housing configured to be attached to an item worn by an animal;
a receiver disposed in the housing and configured to receive an alarm signal;
a signaling device disposed in the housing and configured to transmit a locator signal; and
a processor disposed in the housing and connected to the receiver and the signaling device, the processor being configured to cause the signaling device to transmit the locator signal when the alarm signal is received by the receiver.

2. The locator device of claim 1, wherein:
the signaling device comprises at least one of a visual display, an audio transmitter, and an electromagnetic transmitter; and
the locator signal comprises at least one of a visible signal, an audio signal, and a data signal.

3. The locator device of claim 1, wherein:
the receiver comprises a microphone;
the alarm signal comprises an audio tone; and
the processor is further configured to analyze the audio tone to determine the presence of an alarm event.

4. The locator device of claim 1, wherein:
the receiver comprises an antenna; and
the alarm signal comprises a data signal.

5. The locator device of claim 1, further comprising:
an input device in communication with the processor;
wherein the processor is further configured to cause the signaling device to transmit the locator signal when the processor receives a command from the input device.

6. A system for locating a remote object comprising:
an alarm detector comprising an alarm sensor configured to detect an alarm event and a transmitter connected to the alarm sensor, the transmitter being configured to transmit an alarm signal in response to a detected alarm event; and
a locator device comprising a housing configured to be attached to an item worn by an animal, a receiver disposed in the housing and configured to receive the alarm signal, a signaling device disposed in the housing and configured to transmit a locator signal, and a processor disposed in the housing and connected to the receiver and the signaling device, the processor being configured to cause the signaling device to transmit the locator signal when the alarm signal is received by the receiver.

7. The system of claim 6, further comprising:
a remote device comprising a remote receiver configured to receive the locator signal and a display configured to display locator information when the locator signal is received;
wherein the locator information comprises an indication of a proximity between the remote device and the locator device.

8. The system of claim 7, wherein:
the locator device further comprises a first GPS receiver;
the remote device further comprises a second GPS receiver;
the locator signal contains data obtained by the first GPS receiver; and
the locator information comprises data obtained by the first GPS receiver and the second GPS receiver.

9. The system of claim 6, wherein the alarm sensor comprises:
a microphone configured to receive an audio tone; and
a sensor processor connected to the microphone, the sensor processor being configured to analyze the audio tone to determine the presence of an alarm event.

10. The system of claim 6, wherein the alarm sensor comprises:
a vibration sensor configured to detect a vibration; and
a sensor processor connected to the vibration sensor, the sensor processor being configured to analyze the vibration to determine the presence of an alarm event.

11. The system of claim 6, wherein the alarm sensor communicates with a fire alarm control panel configured to indicate the presence of an alarm event.

12. The system of claim 6, wherein:
the signaling device comprises at least one of a visual display, an audio transmitter, and an electromagnetic transmitter; and
the locator signal comprises at least one of a visible signal, an audio signal, and a data signal.

13. The system of claim 6, further comprising:
an input device in communication with the processor;
wherein the processor is further configured to cause the signaling device to transmit the locator signal when the processor receives a command from the input device.

14. A method for locating a remote object comprising:
detecting an alarm signal with an alarm sensor and a processor in communication with the alarm sensor; and
transmitting a locator signal in response to the detection of the alarm signal;
wherein the processor is disposed within a housing configured to be worn by an animal.

15. The method of claim 14, wherein the locator signal comprises at least one of a visible signal, an audio signal, and a data signal.

16. The method of claim 14, wherein:
the alarm signal comprises an audio tone; and
the detecting comprises analyzing the audio tone to determine the presence of an alarm event.

17. The method of claim 14, wherein the detecting comprises sensing a vibration of an alarm device.

18. The method of claim 14, further comprising:
receiving the locator signal in a remote device; and
displaying locator information when the locator signal is received;
wherein the locator information comprises an indication of a proximity between the remote device and a source of the locator signal.

19. The method of claim 18, wherein the locator information comprises GPS coordinates of the remote device and GPS coordinates of the source of the locator signal.

20. An alarm notification device comprising:
a receiver configured to receive an alarm signal;
an audio transmitter configured to transmit an audio signal having a frequency greater than 20 kHz; and
a processor connected to the receiver and the signaling device, the processor being configured to cause the audio transmitter to transmit the audio signal when the alarm signal is received by the receiver.

21. The alarm notification device of claim 20, wherein:
the receiver comprises a microphone;
the alarm signal comprises an audio tone; and
the processor is further configured to analyze the audio tone to determine the presence of an alarm event.

22. The alarm notification device of claim 20, wherein:
the receiver comprises an antenna; and
the alarm signal comprises a data signal.

23. The alarm notification device of claim 20, further comprising:
an input device in communication with the processor;
wherein the processor is further configured to cause the audio transmitter to transmit the audio signal when the processor receives a command from the input device.

24. A system for notifying an animal that an alarm is active comprising:
an alarm detector comprising an alarm sensor configured to detect an alarm event and a transmitter connected to the alarm sensor, the transmitter being configured to transmit an alarm signal in response to a detected alarm event; and
an alarm notification device comprising a receiver configured to receive the alarm signal, an audio transmitter configured to transmit an audio signal having a frequency greater than 20 kHz, and a processor connected to the receiver and the signaling device, the processor being configured to cause the audio transmitter to transmit the audio signal when the alarm signal is received by the receiver.

25. The system of claim 24, wherein the alarm sensor comprises:
a microphone configured to receive an audio tone; and
a sensor processor connected to the microphone, the sensor processor being configured to analyze the audio tone to determine the presence of an alarm event.

26. The system of claim 24, wherein the alarm sensor comprises:
a vibration sensor configured to detect a vibration; and
a sensor processor connected to the vibration sensor, the sensor processor being configured to analyze the vibration to determine the presence of an alarm event.

27. The system of claim 24, wherein the alarm sensor communicates with a fire alarm control panel configured to indicate the presence of an alarm event.

28. The system of claim 24, further comprising:
an input device in communication with the processor;
wherein the processor is further configured to cause the audio transmitter to transmit the audio signal when the processor receives a command from the input device.

29. A method for notifying an animal that an alarm is active comprising:
detecting an alarm signal with an alarm sensor and a processor in communication with the alarm sensor; and
transmitting an audio signal having a frequency greater than 20 kHz in response to the detection of the alarm signal.

30. The method of claim 29, wherein:
the alarm signal comprises an audio tone; and
the detecting comprises analyzing the audio tone to determine the presence of an alarm event.

31. The method of claim 29, wherein the detecting comprises sensing a vibration of an alarm device.
